(19) United States
(12) Patent Application Publication
(10) Pub. No.: US 2019/0146597 A1
(43) Pub. Date: May 16, 2019

(54) ILLUMINATED PATTERNS

(71) Applicant: HEWLETT-PACKARD DEVELOPMENT COMPANY, L.P., Houston, TX (US)

(72) Inventors: Nathan Barr Nuber, Fort Collins, CO (US); Steven Steinmark, Fort Collins, CO (US)

(73) Assignee: HEWLETT-PACKARD DEVELOPMENT COMPANY, L.P., Houston, TX (US)

(21) Appl. No.: 16/098,116

(22) PCT Filed: Jul. 27, 2016
(86) PCT No.: PCT/US2016/044256

§ 371 Date: Oct. 31, 2018

(51) Int. Cl. G06F 3/03; G06T 7/73; G06F 3/0354; G06F 3/042; G06F 3/038

(52) U.S. Cl. CPC G06F 3/0317; G06T 7/73; G06F 3/03542; G06F 2203/04109; G06F 3/0425; G06F 3/038; G06F 3/03545

(57) ABSTRACT

In one example, a system for illuminated patterns includes a substrate comprising a number of features to emit an illuminated pattern from the substrate, wherein the number of features identify a corresponding position on a display.

### BACKGROUND

In some examples, computing devices can include a number of input devices. These input devices can be utilized to generate inputs for the computing device. In some examples, the input devices can include a stylus or pen shaped device to simulate drawing on a user interface of the computing device. In some examples, a stylus and/or computing device can utilize a navigation pattern to identify a location of the stylus. In some examples, the stylus can include a light emitting diode (LED) to illuminate the navigation pattern.

### BRIEF DESCRIPTION OF THE DRAWINGS

FIG. 1 illustrates an example system for illuminated navigation patterns consistent with the present disclosure.

FIG. 2 illustrates an example system for illuminated navigation patterns consistent with the present disclosure.

FIG. 3 illustrates an example system for illuminated navigation patterns consistent with the present disclosure.

FIG. 4 illustrates an example system for illuminated navigation patterns consistent with the present disclosure.

FIG. 5 illustrates an example computing device for illuminated navigation patterns consistent with the present disclosure.

### DETAILED DESCRIPTION

A number of systems, devices, and methods for illuminated navigation patterns are described herein. In some examples, a system for illuminated navigation patterns includes a light source coupled to a substrate comprising a number of features to emit an illuminated pattern from the substrate, wherein the number of features identify a corresponding position on a display. In some examples, the systems for illuminated navigation patterns can be utilized with a stylus that includes a camera to capture an image of a portion of the illuminated navigation pattern. In some examples, the stylus can transmit the captured image to a computing device. The computing device can utilize the captured image of the portion of the illuminated navigation pattern to determine a location of the stylus.

In some examples, the stylus may utilize an embedded light source (e.g., internal light source, etc.) to illuminate a non-illuminated navigation patterns. As used herein, a non-illuminated navigation pattern includes a navigation pattern or image that is not generated by a light source. For example, a non-illuminated navigation pattern can include a pattern generated by a plurality of shapes (e.g., dots, lines, etc.) that are deposited with ink on a substrate. In this example, the stylus can utilize a light source, such as an LED or laser, to illuminate the non-illuminated navigation pattern to capture an image. The illuminated navigation pattern can generate the same or similar pattern of shapes with a light source to allow a stylus without an embedded light source to be utilized. Utilizing a stylus without a light source can reduce power usage of the stylus while in use.

In some examples, the illuminated navigation patterns described herein can be generated with a light source coupled to a substrate. In some examples, the substrate can include a number of surface features that can be utilized to direct light from the light source out of the substrate. In some examples, the substrate can utilize total internal reflection to substantially encase the provided light within the substrate. In these examples, the surface features can be utilized to emit light from the substrate in designated areas to form an image, pattern, and/or navigation pattern as described herein.

In some examples, the illuminated navigation patterns generated by the portions of light can be utilized by a stylus without the aid of an embedded LED source. For example, systems and methods that utilize non-illuminated navigation patterns can utilize a light source, such as an LED, to illuminate the non-illuminated navigation pattern. In this example, the light source can be utilized by the stylus or camera, which can draw power from the stylus or camera. Thus, in some examples, the systems described herein can utilize a camera or stylus that can utilize relatively less power compared to a camera or stylus that includes a light source.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

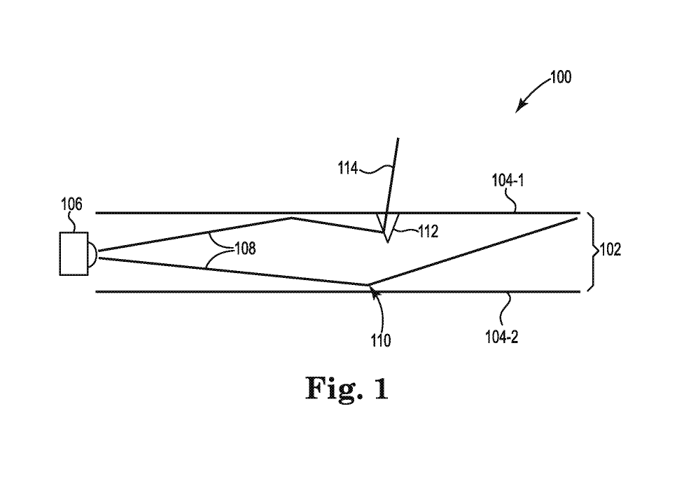

FIG. 1 illustrates an example system 100 for illuminated navigation patterns consistent with the present disclosure. In some examples, the system 100 can illustrate a substrate 102 that can be utilized to generate an illuminated navigation pattern. As described herein, the image and/or navigation pattern can be generated by a number of surface features 112 that emit a portion of light 114 from the substrate at designated areas of the substrate 102.

In some examples, the system 100 can include a light source 106 that is coupled to the substrate 102. In some examples, the light source 106 can be a light emitting diode (LED) (e.g., infrared LED, etc.), In some examples, the light source 106 can be a laser source. In some examples, the light source 106 can include an optic, such as a lens, to focus the light from the light source 106 into the substrate 102. In some examples, the optic can focus the light substantially parallel to the substrate 202. In some examples, the light source 106 can be coupled to the substrate 102 with a light pipe. As used herein, a light pipe can be a device that can transfer light from a first location to a second location. In some examples, the light pipe can provide total internal reflection to prevent lost light from the light source 106.

In some examples, the substrate 102 can include a first surface 104-1 and a second surface 104-2. As described herein, the light source 106 can provide light 108 within the substrate 102. In some examples, the provided light 108 can be reflected within the substrate 102. For example, the provided light 108 can be reflected by the second surface 104-2 at 110. In some examples, the substrate 102 can prevent the provided light 108 from escaping the substrate 102 by internally reflecting the provided light 108 on an interior portion of the first surface 104-1 and/or interior portion of the second surface 104-2.

In some examples, the substrate 102 can comprise a substantially uniform material. In some examples, the substrate 102 can include a glass material, a polycarbonate material, a resin material, and/or a combination thereof. In some examples, the substrate 102 can provide total internal reflection of light 108 within the material. In some examples, the substrate 102 can include a number of surface features 112. In some examples, the number of surface features 112 can be positioned on, or near, the first surface 104-1 of the substrate 102. In some examples, the number of surface features 112 can be positioned on, or near, the second surface 104-2 of the substrate 102. In some examples, the surface features 112 can be positioned near the substrate 102 or can be on a material (e.g., plastic film, etc.) that is coupled to the substrate 102 with a bonding or coupling material (e.g., resin, transparent glue, etc.). For example, a navigation pattern can be printed on a plastic film that can be coupled to the substrate 102 with a resin material.

In some examples, the number of surface features 112 can allow the provided light 108 from the light source 106 to escape the substrate 102. In some examples, the substrate 102 can include a plurality of surface features 112 at designated locations within the substrate 102. For example, the surface features 112 can be positioned such that the portion of light 114 emitted from the substrate 102 generates an image such as a navigation pattern. In some examples, the number of surface features 112 can comprise a different material than the substrate 102. In some examples, the number of surface features 112 can comprise a reflective material to direct the provided light 108 out of the substrate 102. For example, the reflective material can include, but is not limited to: a resin material, a metallic material, and/or a mirror plated material.

In some examples, the navigation pattern generated by the portions of light 114 emitted from the substrate 102 can be utilized to determine a location of a camera or stylus utilizing a camera. For example, a particular portion of light 114 utilized to generate the navigation pattern (e.g., illuminated navigation pattern, etc.) can correspond to a particular location on the substrate. In this example, each of the plurality of surface features 112 can be utilized to emit portions of light 114 that correspond to a particular location on the substrate 102.

In some examples, the plurality of surface features 112 can be positioned on or within the substrate 102 to emit portions of light 114 at specific positions such that the navigation pattern is generated. For example, positioning the plurality of surface features 112 at particular locations can generate portions of light 114 emitted from the substrate. In this example, an illuminated navigation pattern can be generated by the portions of light 114 emitted from the substrate corresponding to the surface features positioned at the particular locations.

In some examples, a computing device can be utilized to determine the location of the camera or the stylus based on the portion of light 114 emitting from the substrate 102 and/or a portion of the navigation pattern. In some examples, the portions of light 114 that exit the substrate 102 can generate macroscopic points (e.g., shapes, dots, lines, etc.) illuminated by focused light directed out of the substrate 102 by the number of surface features 112.

In some examples, the illuminated navigation patterns generated by the portions of light 114 can be utilized by a stylus without the aid of an embedded LED source. For example, systems and methods that utilize non-illuminated navigation patterns can utilize a light source, such as an LED, to illuminate the non-illuminated navigation pattern. In this example, the light source can be utilized by the stylus or camera, which can draw power from the stylus or camera. Thus, in some examples, the system 100 can utilize a camera or stylus that can utilize relatively less power compared to stylus or camera systems that utilize a light source.

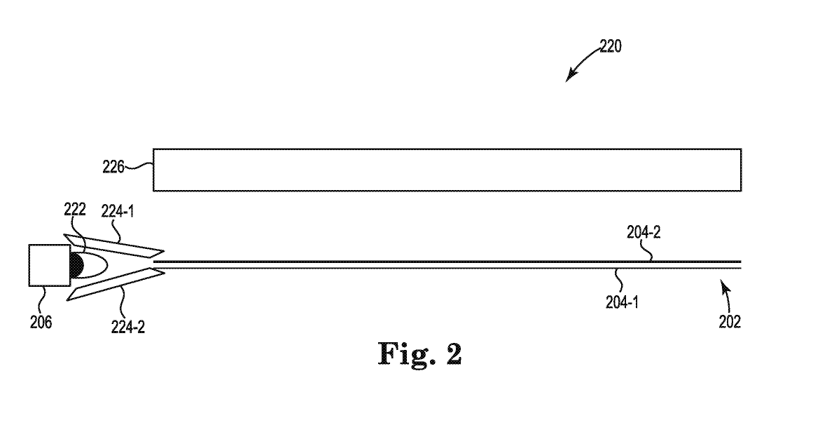

FIG. 2 illustrates an example system 220 for illuminated navigation patterns consistent with the present disclosure. In some examples, the system 220 can include a substrate 202 that can comprise a first surface 204-1 and a second surface 204-2. In some examples, the substrate 202 can comprise the same or similar materials as substrate 102 as referenced in FIG. 1. In some examples, the system 220 can include a display 226 (e.g., user interface, liquid crystal display, etc.) that is coupled to a computing device (not shown).

In some examples, the system 220 can include a light source 206. In some examples, the light source 206 can be the same or similar device as light source 106 as referenced in FIG. 1. For example, the light source 206 can be an infrared LED. In some examples, the light source 206 can be coupled to a lens 222. In some example, the lens 222 can be utilized to focus light from the light source 206 into the substrate 202. In some examples, the light provided to the substrate 202 can be focused by the lens 222 to provide the light substantially parallel to the substrate 202. In some examples, the light source 206 can be positioned between a number of mirrors 224-1, 224-2 that can direct the light from the light source 206 into the substrate 202. In some examples, the number of mirrors 224-1, 224-2 can create an area of total internal reflection between the light source 206 and the substrate 202.

As described herein, the substrate 202 can include a number of surface features to allow portions of light to exit the substrate 202 at designated positions. In some examples, the number of surface features can allow portions of light to exit the substrate 202 to generate an illuminated navigation pattern and/or an illuminated image that can be utilized to determine a location of a stylus or camera as described herein. In some examples, the portions of light that exit the substrate 202 can generate macroscopic points illuminated by focused light directed out of the substrate 202 by the number of surface features.

In some examples, the display 226 can be utilized to display images and/or data generated by the computing device. In some examples, the computing device can utilize a number of input devices to receive inputs from a user. For example, the number of input devices can include a stylus that can be utilized to make selection inputs from the display 226. In some examples, the stylus can include a camera to capture images of the illuminated navigation pattern generated on the substrate 202. In some examples, the stylus can include a transmitter (e.g., radio transmitter, wireless communication transmitter, etc.) to send captured images of the illuminated navigation pattern and/or data corresponding to the captured images of the illuminated navigation pattern to the computing device. In some examples, the computing device can utilize the captured images and/or data corresponding to the captured images to determine a location of the stylus or camera.

In some examples, the substrate 202 can be a substantially transparent material. For example, the substrate 202 can comprise one of: a glass material, a polycarbonate material, a resin material, and/or a combination thereof. In some examples, the substrate 202 can be positioned in line with the display 226 and/or laid over the display 226. For example, the substrate 202 can be positioned on or over the display 226 such that the substrate 202 can be utilized to identify a location or position of a stylus with reference to the display 226.

In some examples, the computing device can determine a position of the stylus on the substrate 202. In these examples, the computing device can utilize the position of the stylus on the substrate 202 to identify a corresponding position of the stylus on the display 226. In some examples, the substrate 202 can be utilized to identify the position or location of a selection with the stylus on the display 226. In some examples, the substrate 202 positioned in line with the display 226 can include examples where the substrate 202 is built into the display 226. For example, the substrate 202 can be coupled to the display 226 and/or embedded into the display 226.

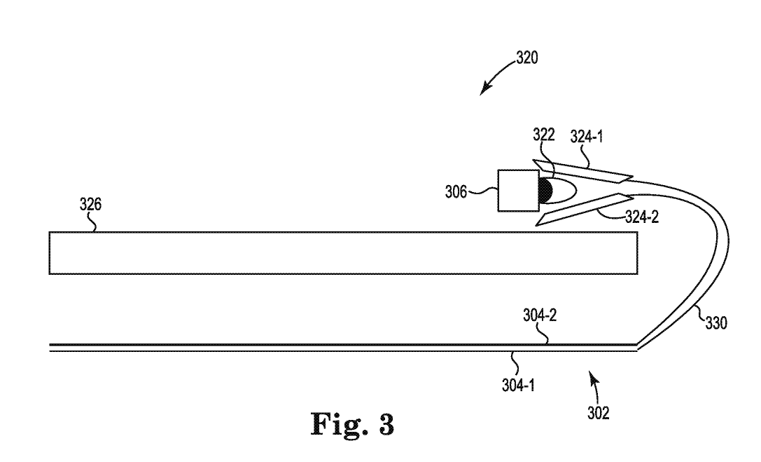

FIG. 3 illustrates an example system 320 for illuminated navigation patterns consistent with the present disclosure. In some examples, the system 320 can include a substrate 302 that can comprise a first surface 304-1 and a second surface 304-2. In some examples, the substrate 302 can comprise the same or similar materials as substrate 102 as referenced in FIG. 1 and/or substrate 202 as referenced in FIG. 2. In some examples, the system 320 can include a display 326 (e.g., user interface, liquid crystal display (LCD), etc.) that is coupled to a computing device (not shown).

In some examples, the system 320 can include a light source 306. In some examples, the light source 306 can be the same or similar device as light source 106 as referenced in FIG. 1. For example, the light source 306 can be an infrared LED. In some examples, the light source 306 can be coupled to a lens 322. In some example, the lens 322 can be utilized to focus light from the light source 306 into the substrate 302 via a light pipe 330. In some examples, the light pipe 330 can utilize total internal reflection to prevent light from emitting from the light pipe 330 as described herein. In some examples, the light pipe 330 can be utilized to transmit light from the light source 306 to the substrate 302. For example, the light pipe 330 can be utilized to allow the light source 306 to be in a location behind the display 326 or away from the substrate 302.

In some examples, the light provided to the substrate 302 can be focused by the lens 322 or light pipe 330 to provide the light substantially parallel to the substrate 302. In some examples, the light source 306 can be positioned between a number of mirrors 324-1, 324-2 that can direct the light from the light source 306, through the light pipe 330, and into the substrate 302. In some examples, the number of mirrors 324-1, 324-2 can create an area of total internal reflection between the light source 206 and the light pipe 330.

As described herein, the substrate 302 can include a number of surface features to allow portions of light to exit the substrate 302 at designated positions. In some examples, the number of surface features can allow portions of light to exit the substrate 302 to generate an illuminated navigation pattern and/or an illuminated image that can be utilized to determine a location of a stylus or camera as described herein. In some examples, the portions of light that exit the substrate 302 can generate macroscopic points illuminated by focused light directed out of the substrate 302 by the number of surface features.

In some examples, the display 326 can be utilized to display images and/or data generated by the computing device. In some examples, the computing device can utilize a number of input devices to receive inputs from a user. For example, the number of input devices can include a stylus that can be utilized to make selection inputs from the display 326. In some examples, the stylus can include a camera to capture images of an illuminated navigation pattern generated on the substrate. In some examples, the stylus can include a transmitter (e.g., radio transmitter, wireless communication transmitter, etc.) to send captured images of the illuminated navigation pattern and/or data corresponding to the captured images of the illuminated navigation pattern to a computing device. In some examples, the computing device can utilize the captured images and/or data corresponding to the captured images to determine a location of the stylus or camera.

In some examples, the substrate 302 can be a substantially transparent material. For example, the substrate 302 can comprise one of: a glass material, a polycarbonate material, a resin material, and/or a combination thereof. In some examples, the substrate 302 can be positioned in line with the display 326 and/or laid over the display 326. For example, the substrate 302 can be positioned on or over the display 326 such that the substrate 302 can be utilized to identify a location or position of a stylus with reference to the display 326. In some examples, the substrate 302 can be utilized to identify the position or location of a selection with the stylus on the display 326.

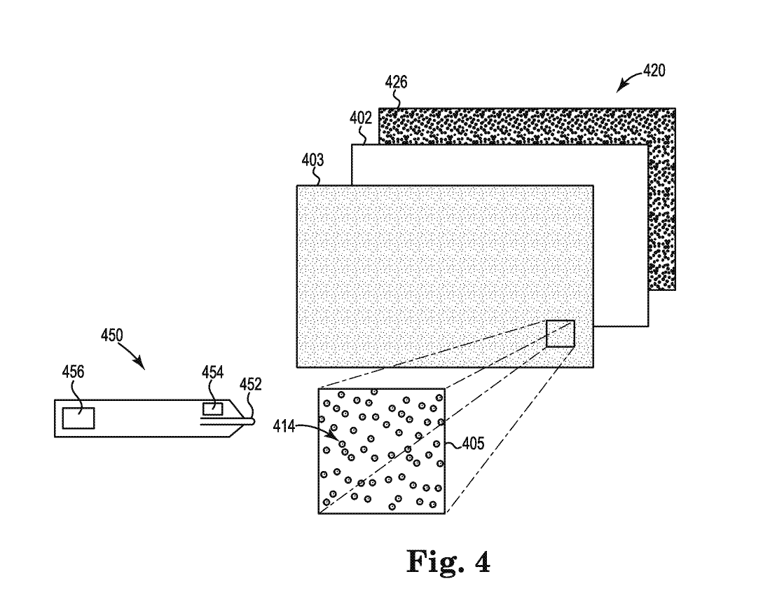

FIG. 4 illustrates an example system 420 for illuminated navigation patterns consistent with the present disclosure. In some examples, the system 420 can include a substrate 402 that can comprise a first surface and a second surface as described herein. In some examples, the substrate 402 can comprise the same or similar materials as substrate 102 as referenced in FIG. 1, substrate 202 as referenced in FIG. 2, and/or substrate 302 as referenced in FIG. 3.

In some examples, the system 420 can include a display 426 (e.g., user interface, LCD display, etc.). In some examples, the display 426 can be the same or similar display as display 226 as referenced in FIG. 2 and/or display 326 as referenced in FIG. 3. The substrate 402 is shown separate from the display 426 for ease of illustration. In some examples, the substrate 402 can be coupled to the display 426 as described herein. In some examples, the substrate 402 can be embedded within the display 426 and/or a within a case of the display 426.

In some examples, the substrate 402 can be utilized to generate an image 403 (e.g., illuminated navigation pattern, etc.) utilizing a number of features (e.g., surface features, etc.) to emit light from the substrate 402. The image 403 is shown separate from the substrate 402 for ease of illustration. However, in some examples, the image 403 can be emitted from the surface of the substrate 402 as described herein.

In some examples, the system 420 can include a stylus 450 (e.g., input device, etc.). In some examples, the stylus 450 can include an input 452, a camera 454, and/or a transmitter 456, among other features. In some examples, the input 452 can be an aperture or similar opening to allow the camera 454 to capture the image 403 and/or a portion 405 of the image 403. In some examples, the input 452 can be utilized as a “position” of the camera 454. For example, a user can utilize the input 452 to select or point at objects on the display 426. In this example, the image 403 can be utilized to determine a “location” of the input 452 with reference to the display 426.

In some examples, the camera 454 can be utilized to capture a portion 405 of the image 403. In some examples, the portion 405 of the image 403 can be utilized to determine a location of the camera 454 and/or input 452 as described herein. In some examples, the stylus 450 can include a transmitter 456. In some examples, the stylus 450 can capture a portion 405 of the image 403 and transmit the portion 405 of the image 403 to a computing device. In some examples, the computing device can utilize the captured image (e.g., portion 405 of the image 403) to determine a location of the stylus 450 with reference to the substrate 402 and/or the display 426.

In some examples, the image 403 can comprise a plurality of illuminated elements 414 that are generated when a corresponding surface features emit or direct light from the substrate 402. The illuminated elements 414 can be disposed on the substrate 402 in a unique, specific, spatial or positional pattern, as shown in the portion 405 as a magnified view of the arrangement of illuminated elements 414 on the substrate 402. The use of such a pattern creates a positional relationship between the illuminated elements 414 based on their location on the substrate 402 and/or display 426.

The positional relationship between illuminated elements 414 can be read (e.g., captured by the camera, analyzed by a computing device, etc.) to determine a specific location on the substrate 402 and/or display 426. The transparency of illuminated elements 414 and the substrate 402 upon which the illuminated elements 414 are disposed permits the use of such systems and methods with display apparatuses. A transparent, predetermined encoded pattern of illuminated elements 414 disposed in, on, or about a transparent substrate 402 can provide input systems (e.g., stylus 450, etc.) and methods with a high degree of accuracy while maintaining a high fidelity visual display of a printed page.

Detection based technologies employing a detector (e.g., camera 454, computing device, etc.) can use a predetermined series of the illuminated elements 414 applied in the form of fiducials, dots, or similar marks. The marks are used to ascertain information from the encoded pattern (e.g., a position on the display 426). The positional relationship between the illuminated elements 414 on the display 426 permit information to be determined by a detector and associated electronics/software. As the illuminated elements 414 emit a signal of from the display 426, a camera 454 located proximate the display 426 can sense or capture the emitted signal of light.

In some examples, the illuminated navigation patterns generated by the illuminated elements 414 (e.g., emitted light 114 as referenced in FIG. 1, etc.) can be utilized by the stylus 450 without the aid of an embedded LED source. For example, systems and methods that utilize non-illuminated navigation patterns can utilize a light source, such as an LED, to illuminate the non-illuminated navigation pattern. In this example, the light source can be utilized by the stylus or camera, which can draw power from the stylus or camera. Thus, in some examples, the system 420 can utilize a camera 454 and/or stylus 450 that can utilize relatively less power compared to a camera or stylus that includes a light source.

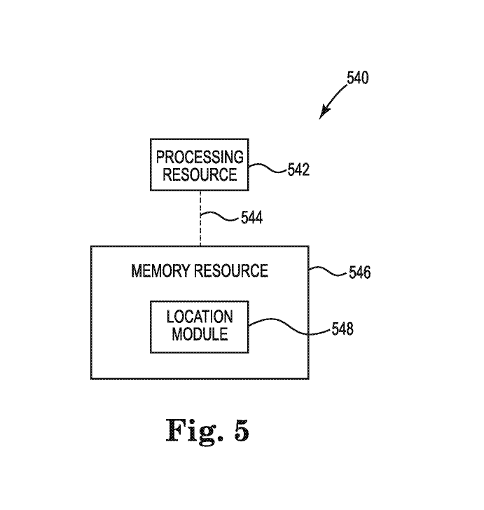

FIG. 5 illustrates an example computing device for illuminated navigation patterns consistent with the present disclosure. The computing device 540 can utilize software, hardware, firmware, and/or logic to perform functions described herein (e.g., determine a location of a camera or stylus, receive image data, receive data corresponding to an image, etc.).

The computing device 540 can be any combination of hardware and program instructions to share information. The hardware, for example, can include a processing resource 542 and/or a memory resource 546 (e.g., non-transitory computer-readable medium (CRM), machine readable medium (MRM), database, etc.), A processing resource 542, as used herein, can include any number of processors capable of executing instructions stored by a memory resource 546. Processing resource 542 can be implemented in a single device or distributed across multiple devices. The program instructions (e.g., computer readable instructions (CRI)) can include instructions stored on the memory resource 546 and executable by the processing resource 542 to implement a desired function (e.g., receive the image of the provided light, display images on a display or user interface, determines a location of the camera based on the image of the provided light, utilize the data corresponding to the portion of the image to determine a location of the stylus, etc.).

The memory resource 546 can be in communication with the processing resource 542 via a communication link (e.g., a path) 544. The communication link 544 can be local or remote to a machine (e.g., a computing device) associated with the processing resource 542. Examples of a local communication link 544 can include an electronic bus internal to a machine (e.g., a computing device) where the memory resource 546 is one of volatile, non-volatile, fixed, and/or removable storage medium in communication with the processing resource 542 via the electronic bus.

A number of modules (e.g., location module 548, etc.) can include CRI that when executed by the processing resource 542 can perform functions. The number of modules (e.g., location module 548, etc.) can be sub-modules of other modules. For example, the location module 548 can be a sub-module and/or contained within the same device. In another example, the number of modules (e.g., location module 548, etc.) can comprise individual modules at separate and distinct locations (e.g., CRM, etc.).

As used herein, “a” or “a number of” something can refer to one such thing or a plurality of such things. For example, “a number of devices” can refer to one device or a plurality of devices. Additionally, the designator “N”, as used herein, particularly with respect to reference numerals in the drawings, indicates that a number of the particular feature so designated can be included with a number of examples of the present disclosure.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A device for illuminated patterns, comprising:
a substrate comprising a number of features to emit an illuminated pattern from the substrate, wherein the number of features identify a corresponding position on a display.

2. The device of claim 1, wherein the number of features are surface features coupled to the substrate that allow light from a light source to exit the substrate.

3. The device of claim 1, wherein the substrate provides total internal reflection other than a number of positions corresponding to the number of features.

4. The device of claim 1, wherein the substrate is a transparent substrate.

5. The device of claim 1, wherein the number of features allows provided light to exit the substrate at designated locations of the substrate to generate the illuminated pattern.

6. A system for illuminated patterns, comprising:
a substrate comprising a number of surface features; and
a light source coupled to the substrate to provide light to the substrate, wherein the provided light is directed out of the substrate via the number of surface features to generate an image.

7. The system of claim 6, comprising a computing device to receive the image of the provided light.

8. The system of claim 7, wherein the computing device determines a location of a camera based on the image of the provided light.

9. The system of claim 6, wherein the light source is an infrared light emitting diode (LED) or a laser.

10. The system of claim 6, comprising a camera embedded in a stylus to provide a portion of the image to a computing device.

11. The system of claim 10, wherein the light source is coupled to the substrate with a light pipe.

12. A system for illuminated patterns, comprising:
a light source coupled to a lens to focus light parallel to a substrate that includes a number of surface features, wherein the focused light is directed out of the substrate via the number of surface features to generate an image; and
a stylus, comprising:
a camera to capture a portion of the image; and
a transmitter to transmit data corresponding to the portion of the image to a computing device.

13. The system of claim 12, wherein the computing device utilizes the data corresponding to the portion of the image to determine a location of the stylus.

14. The system of claim 12, wherein the image is an illuminated pattern comprising a plurality of macroscopic points illuminated by the focused light directed out of the substrate.

15. The system of claim 12, wherein the substrate comprises one of;
a glass material;
a polycarbonate material; and
a resin material.
